(19) United States
(12) Patent Application Publication
(10) Pub. No.: US 2001/0012791 A1
(43) Pub. Date: Aug. 9, 2001

(54) MOBILE RADIO WITH TIME DISPLAY FUNCTION

(76) Inventors: RYUJI MIYAKE, TOKYO (JP); SADAMU HIGUCHI, YOKOHAMA-SHI (JP)

Correspondence Address: PEARNE & GORDON LLP, 526 SUPERIOR AVENUE EAST, SUITE 1200, CLEVELAND, OH, 44114-1484, US

(21) Appl. No.: 08/889,636

(22) Filed: Jul. 8, 1997

(30) Foreign Application Priority Data
Jul. 10, 1996 (JP) HEI 8-198510

(51) Int. Cl. H04B 1/16

(52) U.S. Cl. 455/566; 455/66

(57) ABSTRACT

A base station 2 has a GPS receiver 3 in a base station body so as to receive correct time information based on an atomic clock broadcast from a GPS satellite 1. The base station 2 informs a mobile station of present time by transmitting a control signal 4 including time information received by the above-mentioned means. In the mobile radio, a receiving section 6 receives the control signal 4 transmitted from the base station 2, and a signal processing section 7 decodes this received signal so as to extract the time information given by the base station 2 to thereby calculate present time on the basis of this time information. Further, the control section 9 makes the display section 8 display the thus obtained present time to thereby realize the time display function.

### BACKGROUND OF THE INVENTION

The present invention relates to a mobile radio which displays time information, and particularly relates to a mobile radio with a time display function adapted to operate in a mobile communication system in which a mobile station is informed of time information by a control signal transmitted from a base station.

FIG. 3 shows an example of a configuration of a mobile radio with a time display function according to a conventional technique. In FIG. 3, a mobile radio body 5 is constituted by a display section 8, a control section 9, a clock circuit 11 and a backup circuit 12. The clock circuit 11 is constituted by a clock integrated circuit, a quartz oscillator, etc. The clock integrated circuit includes a timer and a memory.

Next, the operation of the conventional example of the mobile radio will be described.

When a user sets present time in the initial state of the mobile radio, the clock circuit 11 starts its operation. Thereafter, in accordance with the control section 9, the present time renewed by the clock circuit 11 is displayed in the display section 8 to realize the time display function. In addition, the backup circuit 12 for supplying auxiliary power to the clock circuit 11 is provided lest the present time information should be lost even in a condition where power is not supplied to the mobile radio body 5.

As has been described above, in the mobile radio with a time display function according to the conventional technique, the time display function is realized by providing the mobile radio body with independent circuits for realizing a time display function such as a clock circuit, a backup circuit and so on.

However, in the configuration of the mobile radio in accordance with the conventional technique, it was inevitable to provide independent additional circuits such as a clock circuit, a backup circuit and so on in order to give a time display function to a mobile radio, so that a problem was caused disadvantageously not only in view of the increased cost but also in view of the increased number of components. In addition, in the initial state, in the case where time information held by a mobile radio was lost, or in the case where errors were accumulated in the time information because of aging or the like, it was necessary for a user to input present time again to correct the time information on all such occasions.

### SUMMARY OF THE INVENTION

It is an object of the present invention to solve the foregoing conventional problems, and to provide a superior mobile radio with a time display function adapted to operate in a mobile communication system in which a mobile station is informed of time information by a control signal transmitted from a base station, wherein the time information can be displayed without providing any independent circuits, the mobile radio being low in price, and small in the number of components, and having no necessity for a user to correct the time information.

In order to attain the foregoing object, according to the present invention, in a mobile radio adapted to operate in a mobile communication system in which a mobile station is informed of time information by a control signal transmitted from a base station, a time display function is given to the mobile radio in a manner as follows. That is, a receiving section for receiving a signal from the base station, a signal processing section for processing the received signal, and a display section for displaying an output signal of the signal processing section are provided in a mobile radio body, so that the control signal transmitted from the base station is received by the receiving section, the time information included in the control signal is extracted by the signal processing section, and present time calculated on the basis of the time information is displayed in the display section.

In addition, a counter for counting elapsed time from reception of the time information is provided in order to attain another object to make the present time renewable even when the time information informed from the base station is not received after reception of the time information from the base station.

### BRIEF DESCRIPTION OF THE DRAWINGS

FIGS. 1A and 1B are block diagrams showing a mobile radio with a time display function adapted to operate in a mobile communication system according to a first embodiment of the present invention;

FIGS. 2A and 2B are block diagrams showing a mobile radio with a time display function adapted to operate in a mobile communication system according to a second embodiment of the present invention;

FIG. 3 is a block diagram showing a conventional mobile radio with a time display function.

### DETAILED DESCRIPTION OF THE PREFERRED EMBODIMENTS

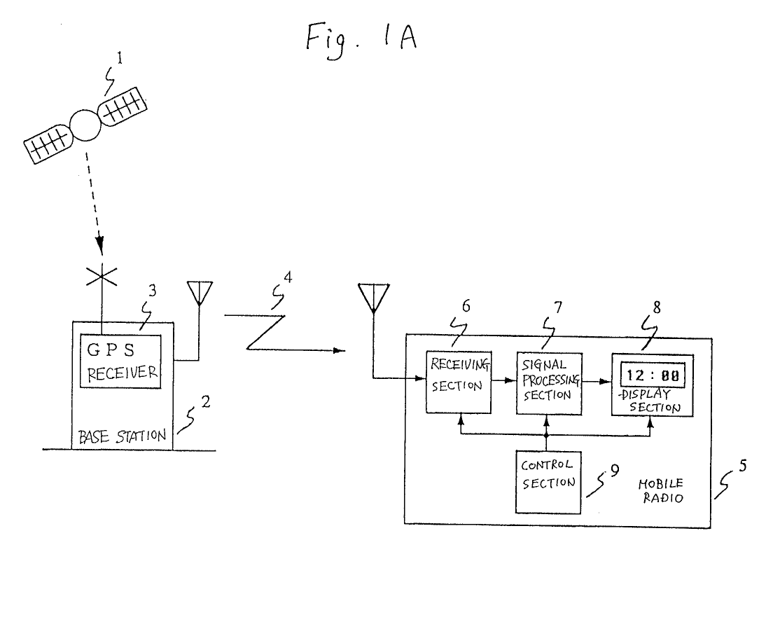

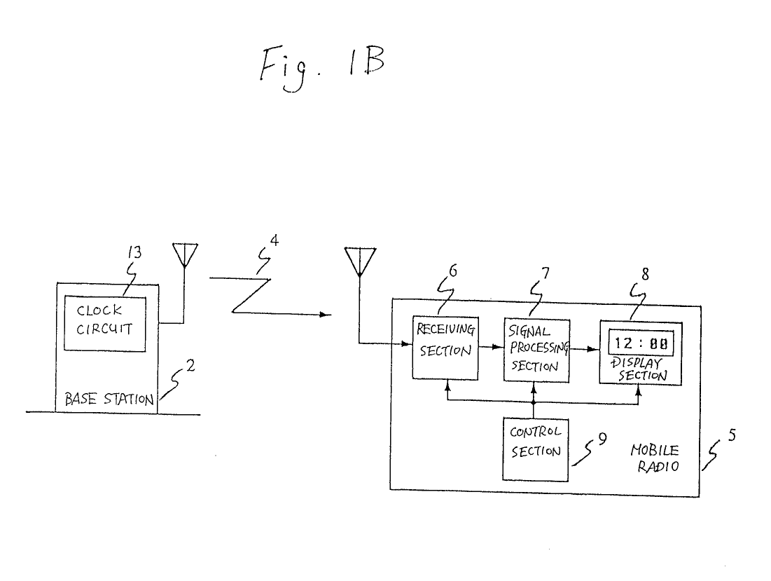

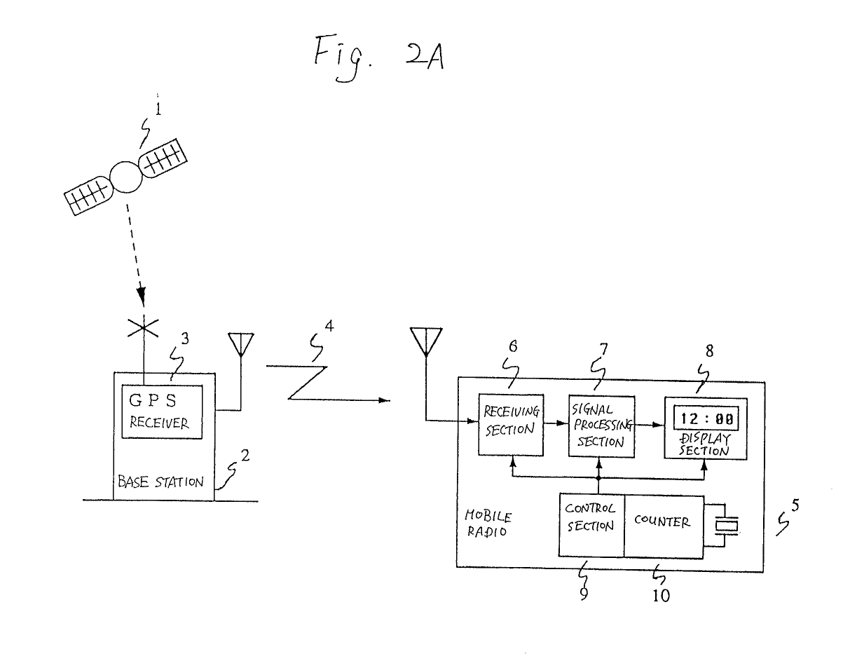

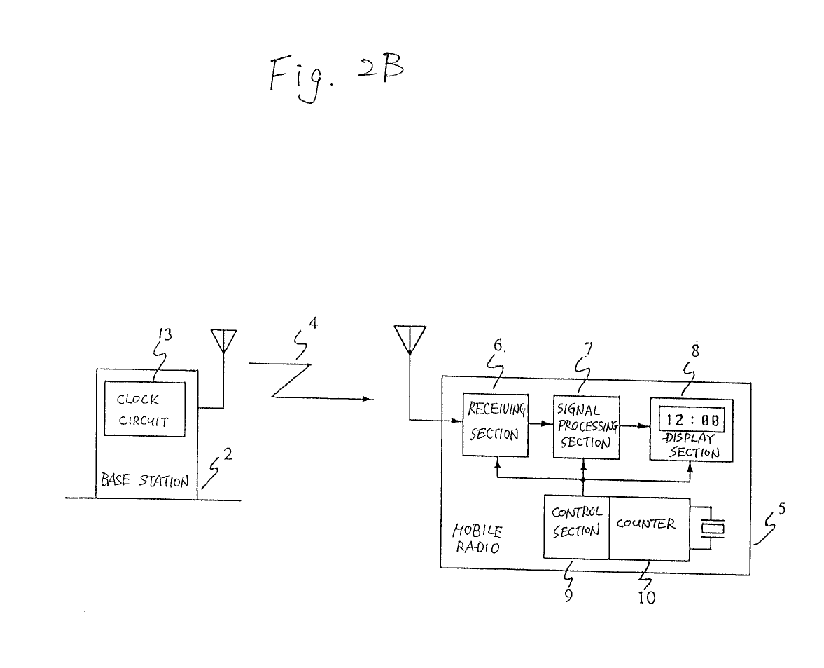

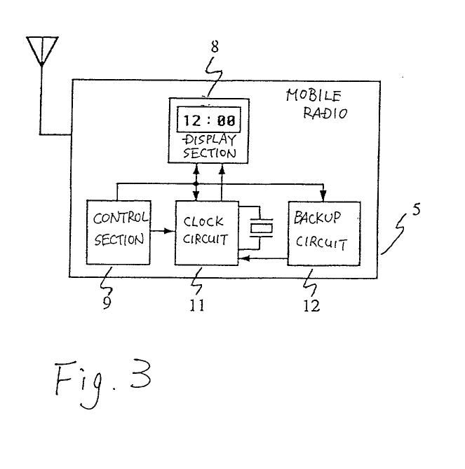

An embodiment of the present invention will be described below with reference to FIGS. 1 and 2.

### First Embodiment

FIG. 1A shows the configuration of a mobile radio with a time display function adapted to operate in a mobile communication system in a first embodiment of the present invention.

In FIG. 1A, a mobile communication system is constituted by a GPS (global positioning system) satellite 1, a base station 2 having a GPS receiver 3 in a base station body, and a mobile station having a mobile radio body 5. The mobile radio body 5 is constituted by a receiving section 6, a signal processing section 7, a display section 8, and a control section 9. Further, a control signal 4 is transmitted from the base station 2 to the mobile station.

Next, the operation of the first embodiment will be described.

The base station 2 has the GPS receiver 3 in the base station body so as to receive correct time information based on an atomic clock broadcast from the GPS satellite 1. In the mobile communication system shown in this embodiment, the base station 2 informs the mobile station of present time by transmitting the control signal 4 including the time information received by the above-mentioned means. In the mobile radio, the receiving section 6 receives the control signal 4 transmitted from the base station 2, and the signal processing section 7 decodes this received signal so as to extract the time information given by the base station 2 to thereby calculate present time from this time information. Further, the control section 9 makes the display section 8 display the thus obtained present time to thereby realize the time display function. Whenever the receiving section 6 receives the control signal 4 from the base station 2 again to thereby obtain new time information, the control section 9 renews the present time to be displayed in the display section 8 on the basis of this new time information.

FIG. 1B shows the modified configuration of a mobile radio with a time display function according to the first embodiment of the present invention.

In stead of the GPS receiver, a clock circuit 13 is provided in the base station to transmit the time information.

### Second Embodiment

FIG. 2A shows a configuration of a mobile radio with a time display function adapted to operate in a mobile communication system in a second embodiment of the present invention.

In FIG. 2A, a mobile radio body 5 is constituted by a receiving section 6, a signal processing section 7, a display section 8, a control section 9, and a counter 10. The configuration of FIG. 2A is the same as that of FIG. 1A except this counter 10. The counter 10 is provided in the mobile radio body 5, and has a function to count elapsed time from the reception of time information given from the base station 2.

Next, the operation of the second embodiment will be described. In the mobile communication system shown in this embodiment, the base station 2 transmits a control signal 4 including time information received by means the same as that in the first embodiment to thereby inform the mobile station of present time. In the mobile radio, the signal processing section 7 extracts the time information given from the base station 2 to thereby calculate present time on the basis of this time information in the same manner as in the first embodiment.

The control section 9 makes the display section 8 display the present time calculated on the basis of the time information. Thereafter, the signal processing section 7 makes the counter 10 count elapsed time from reception of the time information even in the case where no time information is received from the base station 2, so that the output value of the counter 10 is added to the previously calculated present time to thereby renew the present time.

After that, when time information is received again from the base station 2, the present time held by the signal processing section 7 at that time is corrected by using this new time information, and at the same time, the counter 10 is reset to start the renewal of the present time in the same manner.

In such a manner, the newest time calculated successively is displayed in the display section 8 under control by the control section 9 to realize the time display function.

FIG. 2B shows the modified configuration of a mobile radio with a time display function according to the second embodiment of the present invention.

In stead of the GPS receiver, a clock circuit 13 is provided in the base station to transmit the time information.

As is apparent from the above description of the embodiments, the present invention has effects that in a mobile radio adapted to operate in a mobile communication system in which a mobile station is informed of time information by a control signal transmitted from a base station, present time calculated on the basis of this time information is displayed, so that it is possible to give the mobile radio the time display function without providing any independent clock circuit. Thus, it is possible to provide a mobile radio with a time display function at a low price, with the reduced number of components and without necessity for an user to correct time.

What is claimed is:

1. A mobile radio with a time display function adapted to operate in a mobile communication system in which a mobile station receives a control signal transmitted from a base station; said mobile radio comprising:
receiving means for receiving said control signal from said base station, time information being included in said control signal;
signal processing means for extracting said time information from said control signal received by said receiving means; and
display means for displaying a present time based on said time information.

2. A mobile radio with a time display function as claimed in claim 1, further comprising a counter for counting elapsed time from reception of said time information informed from said base station after reception of said time information from said base station.

3. A mobile radio with a time display function as claimed in claim 2, wherein said counter counts elapsed time from the reception of said time information while even in a case where no time information informed is received from said base station.

4. A mobile radio with a time display function as claimed in claim 3, wherein an output value of said counter is added to said present time calculated on the basis of said time information so as to renew said present time.

5. A mobile radio with a time display function as claimed in claim 4, when time information newly informed from said base station is received again, an error of said present time obtained by said signal processing section is corrected by using said newly informed time information so that the newest time information calculated on the basis of said newly informed time information is displayed in said display section.
